(19) United States
(12) Patent Application Publication
(10) Pub. No.: US 2017/0365047 A1
(43) Pub. Date: Dec. 21, 2017

(54) ARTIFACT MANAGEMENT IN IMAGING

(71) Applicant: GENERAL ELECTRIC COMPANY, SCHENECTADY, NY (US)

(72) Inventors: Dirk Bequé, Munich (DE); Florian Wiesinger, Freising (DE)

(21) Appl. No.: 15/182,952

(22) Filed: Jun. 15, 2016

(51) Int. Cl. G06T 7/00; G06T 5/00

(52) U.S. Cl. CPC G06T 7/0002; G06T 7/0012; G06T 7/0008; G06T 5/005; G06T 2207/20004; G06T 2207/30168

(57) ABSTRACT

The system and method of the invention pertains to automated analysis and reconstruction of images from a plurality of imaging devices to determine the presence of different types of artifacts, using signal processing and machine learning algorithms. The method (1) classifies the artifacts according to their cause, (2) selects correction algorithms to address the artifact, or artifact-generating data, and (3) selects the data or sections of the data and/or reconstruction parameters to be corrected. Then, another reconstruction is performed with the selected artifact corrections, yielding a second reconstructed image with less artifact content. The process can be applied iteratively until the artifact content of the reconstructed image is reduced to a satisfactory low level as determined by a user. If the artifacts cannot be addressed by data processing means, the method initiates or recommends alternative artifact management actions.

### FIELD

Embodiments relate generally to the field of imaging, and more particularly to artifact management and correction by image and/or image data analysis.

### BACKGROUND

In medical and industrial imaging, artifacts are a common cause for image rejection, since the artifacts prevent or hinder the analysis of the image content. An artifact is thereby any feature present in the image that does not correspond to the actual patient or object being imaged. Parts of the patient reappearing at other image locations and overlapping the actual image in magnetic resonance imaging (MRI) (i.e., ghosting artifacts) and streaks emanating from dense metallic objects in computed tomography (CT) images (metal artifacts) are well known examples of artifacts. Methods for the reduction of artifacts of various kinds have been developed and are being developed, but their use is typically limited to imaging situations in which that particular type of artifact is likely to occur, e.g. metal artifact correction for pelvic CT imaging of patients with hip implants. In situations, however, where an unanticipated type of artifact occurs, artifact correction requires operator skill and interaction to eliminate the artifact by data processing means, and therefore very often results in having to reacquire the image.

In general terms, artifacts can occur in images when the data acquired from the patient or object are inconsistent with the imaging model, as implicitly or explicitly assumed by the algorithm that generates the reconstructed images from the acquired data. In medical imaging, patient implants such as dental fillings, surgical clips and prostheses are a common cause of artifacts. Also, [involuntary] patient body motion, cardiac and respiratory motion are common sources of artifacts. On the system side, radio-frequency (RF) interference and incorrect gain adjustment from a pre-scan cause artifacts in MM. For CT and single-photon emission computed tomography (SPECT), mechanical system misalignment and failure of detector pixels are sources of artifacts. Finally, the discrete nature of data acquisition approximates the continuous physics models from which the reconstruction algorithms are often based. This leads to streak artifacts in industrial CT of parts with long straight edges. Moreover, many of the causes of artifacts are limited in space (e.g. dental implants, straight edges), or time (e.g. body motion), and thereby affect a portion of the acquired data. Others, such as incorrect gain and mechanical misalignment, affect the entire acquisition, but in a consistent way. As a result, it is often possible to partially correct for the cause of the artifact and generate images of sufficient quality for evaluation. Metal artifact correction in CT is one example. In one circumstance, the correction techniques enable imaging of [parts of] patients and/or objects that could otherwise not be imaged with satisfactory image fidelity. In another circumstance, the correction techniques avoid repeat acquisitions of the same patient or object.

Most artifacts are visually pronounced, such that a person normally skilled in the art is able to identify the presence of the artifact(s) in the image. Visual inspection, typically performed by the operator of the imaging device, therefore normally forms the basis for the decision of acceptance or rejection of the reconstructed image. In case of rejection, the decision can be taken to perform a new acquisition of the patient or object, or to attempt image reconstruction with artifact correction. However, the latter case often involves a person skilled in the art. Persons skilled in the art are able to identify the presence of a single or plurality of artifacts in the image, but to also: (1) classify the artifact as a particular kind(s) as related to a specific cause(s), and to (2) identify parts of the data affected by the artifact and/or the corresponding, often implicit, reconstruction parameter values that are incompatible with the acquired data.

This capability enables the selection of proper artifact correction algorithm(s) and to apply the algorithm(s) to the part(s) of the data affected, such that an image can be reconstructed without or with reduced artifact content. Depending on the type of artifact, it may take several iterations in which specific correction parameter values are adaptively modified until acceptably low artifact content in the reconstructed image is reached. The process of artifact identification, classification and selection of the affected data/parameters is a complicated task that currently only persons especially skilled in the art are capable of performing.

Furthermore, common practice tries to avoid the appearance of artifacts in reconstructed images by applying artifact avoidance strategies. Filtered back-projection image reconstruction e.g. (a wide-spread reconstruction algorithm for CT), requires filtering the data with a ramp filter. In practice, however, the ramp filter is replaced by filters like the Hamming or Hanning window, which suppress the high spatial frequency content of the data in comparison to the ramp filter. The suppression of the high spatial frequencies is beneficial for artifact avoidance, but reduces the information content of the reconstructed image. In MRI, a similar and very common artifact avoidance approach applies a Fermi-filtering to the data before or as part of the image reconstruction process. In both cases, these filters are applied to the entire data set, irrespective of whether a particular section of the data will give rise to artifacts or not. The identification of artifacts in a preliminary image, reconstructed without or with less artifact prevention, and the subsequent determination of those parts of the data that give raise to artifacts, allows the selective application of artifact prevention strategies to the data sections that otherwise cause artifacts. This preserves the information content in other data sections and results in more information content in the final reconstructed image.

The failure and/or wear of system components can also result in artifacts. For example, radiation damage can result in x-ray detector changes (e.g., the response of the detector to x-ray radiation). When the different pixels of a CT detector are unequally affected, ringing artifacts appear in the reconstructed images. The identification of such ringing artifacts, the determination of the detector pixels causing them, and the quantification of the severity of the damage, would be beneficial in future implementation of the invention to yield information about the operational condition of the system that can be reported and used for service planning.

It is desirable to address the needs as stated above. Specifically, artifact correction as addressed herein will utilize automated correction for several types of artifacts at the point of data preparation for image reconstruction and/or at the point of image reconstruction, i.e. prior to evaluation and/or processing of the reconstructed images.

As will be disclosed herein, the invention will further address an automated framework based on the analyzing power of modern data analytics to assist in the identification and management of artifacts in medical and industrial imaging applications. Modern data analysis algorithms, especially machine learning and deep learning algorithms, may be implemented to perform analysis tasks on the images. Furthermore, after the initial learning phase, machine learning algorithms execute fast and are expected to outperform humans in terms of speed for several identification and management subtasks.

### SUMMARY

The system and method of the invention pertains to artifact correction for medical imaging and industrial inspection. The artifact corrections occur such that image reconstruction is repeated prior to processing and/or evaluation of the reconstructed images.

In one embodiment, a system is disclosed comprising a non-transitory computer-readable memory device that enables an imaging system to reconstruct images from one or more imaging devices, the system comprising: an image acquisition module that acquires a plurality of data from the one or more imaging devices; an image reconstruction module comprising one or more parameter values; and an artifact management module that identifies one or more data subsets comprising a plurality of artifacts, wherein the artifact management module accepts or rejects one or more of the plurality of artifacts during at least one of a classification step and an analysis step, alone or in combination; and activates one or more corrections prior to reconstructing an image in the image reconstruction module. The artifact management module manages artifacts by way of acceptance or rejection of one or more of the plurality of artifacts in a final image, display, or report.

Another embodiment demonstrates a method that enables an imaging system to reconstruct images from one or more imaging devices, the method comprising the steps of: providing an image acquisition module to acquire an image data set, wherein the image data set comprises a plurality of image data subsets; providing an image reconstruction module that comprises one or more parameter values; identifying, by way of an artifact management module, one or more of the plurality of image data subsets comprising a plurality of artifacts; accepting or rejecting, by way of the artifact management module, one or more of the plurality of artifacts during at least one of a classification step or an analysis step, alone or in combination; activating, by way of the artifact management module, one or more corrections prior to reconstructing an image in the image reconstruction module; and executing the one or more corrections to adjust one or more reconstruction parameters to create a reconstructed image, wherein the plurality of artifacts in the reconstructed image are reduced; and such that the step of identifying comprises the steps of (a) detecting one or more of the plurality of artifacts, (b) classifying one or more of the plurality of artifacts, and (c) analyzing one or more of the plurality of artifacts.

In addition, embodiments also include a method that enables an imaging system to reconstruct images from one or more imaging devices which comprises a plurality of artifacts of one or more types, the method comprising the steps of: providing an image acquisition module to acquire an image data set, wherein the image data set comprises a plurality of image data subsets; providing an image reconstruction module that manages a plurality of artifacts such that a plurality of reconstruction parameter values are selected, and one or more artifact correction steps initiated to create a reconstructed image; identifying, by way of an artifact management module, one or more data sections that generate artifacts in a reconstructed image; the step of identifying the one or more data sections comprising the steps of (a) detecting one or more artifact data sections, (b) classifying the one or more artifact data sections according to the type, (c) analyzing the one or more artifact data sections to determine a cause of the artifact data, including affected data of the image data subsets and affected reconstruction parameters, and (d) accepting or rejecting the one or more artifact data sections; modifying one or more of the plurality of image data subsets or the reconstruction parameter values to reduce the one or more artifact data sections; automatically activating the one or more artifact correction steps, as based on a recommendation from the processor during the step of modifying; and correcting the artifact data sections by processing the plurality of data subsets as designated by the step of modifying such that the plurality of reconstruction parameter values are reassessed and one or more of the artifact correction steps implemented to create a reconstructed image.

Detailed descriptions of various embodiments are described as follows.

### BRIEF DESCRIPTION OF THE DRAWINGS

FIG. 1 illustrates a schematic representation of an embodiment of the invention.

FIG. 2 depicts a schematic representation of an embodiment of the invention.

### DETAILED DESCRIPTION

Various embodiments will be better understood when read in conjunction with the appended drawings. It should be understood that the various embodiments are not limited to the arrangements and instrumentality shown in the drawings.

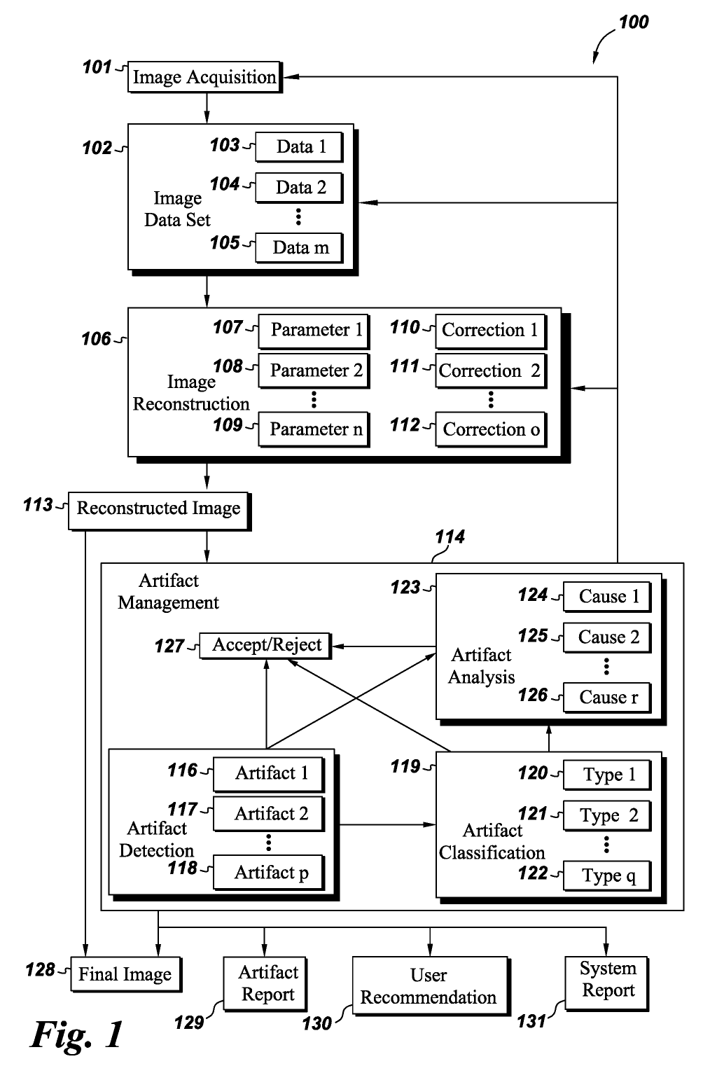

The system and method of the embodiments disclosed herein provide for an image generation method to reduce artifacts. One embodiment, as shown in FIG. 1, illustrates an image generation method 100 of the invention. The image acquisition 101 generates an image data set 102, which comprises a plurality of image data subsets 103, 104, 105. The image reconstruction 106 converts the image data set 102 into the reconstructed image 113, which is suitable for human interpretation. The image reconstruction process 106 is controlled by a plurality of reconstruction parameter values 107, 108, 109, and comprises a plurality of artifact correction steps 110, 111, 112. For the first pass through the image reconstruction step 106, the artifact correction steps 110, 111, 112 are deactivated, but in subsequent passes can be activated. The artifact management module 114 identifies and analyses the artifacts present in the reconstructed image 113. The artifact management module 114 comprises the artifact detection step 115, the artifact classification step 119, the artifact analysis step 123, and the acceptance/rejection step 127. The artifact detection step 115 detects the artifacts present in the reconstructed image 113, resulting in the detected artifacts 116, 117, 118 (e.g., Artifact 1, Artifact 2, . . . Artifact p). The artifact classification step 119 determines the type of the artifacts 116, 117, 118 resulting in the artifact types 120, 121, 122 present in the reconstructed image 113. The artifact analysis step 123 determines the causes 124, 125, 126 of the artifacts 116, 117, 118, taking their type 120, 121, 122 into account, and identifies the data from the data subsets 103, 104, 105 and the parameters from the reconstruction parameters 107, 108, 109 that cause or are affected by the artifacts 116, 117, 118.

The acceptance/rejection step 127 evaluates if the artifact content of the reconstructed image 113 is low enough (as pre-determined by a user) to release the reconstructed image 113 as the final image 128 based on the results of the artifact management module 114, including artifact detection, classification, and analysis. If the artifact content of the reconstructed image 113 is not sufficiently low (as predefined or desired by a user), the artifact management module 114 performs at least one of the following steps, alone or in combination:
(a) modification of the artifact-causing/artifact-affected data subsets of the image data set 102 to mitigate or reduce the artifacts 116, 117, 118 (e.g. modifying 104, but not 103 and 105);
(b) modification of the artifact-causing reconstruction parameter values of the image reconstruction step 106 to mitigate or reduce the artifacts 116, 117, 118 (e.g. modifying 108, but not 107 and 109);
(c) activation of the artifact correction steps from 110, 111, 112 in the reconstruction step 106 that are required to mitigate or reduce the artifacts 116, 117, 118;
(d) ordering the image acquisition step 101 to reacquire any one or more data subsets 103, 104, 105 that include any one of the artifact data 116 or 117 or 118 (e.g. ordering reacquisition of data 104, but not of data 103 or 105).

The image reconstruction step 106 is then repeated, yielding a new reconstructed image 113. If the artifact content of the reconstructed image 113 is low enough (as pre-determined by a user), the following are designated, alone or in combination:
(a) The reconstructed image 113 is accepted as the final image 128;
(b) The artifact report 129 as to any remaining and/or resolved artifacts may be generated;
(c) Recommendations 130 with respect to the remaining and/or resolved artifacts may be issued and/or displayed to the user;
(d) The system report 131 regarding one or more operational conditions of the imaging device(s) may be generated.

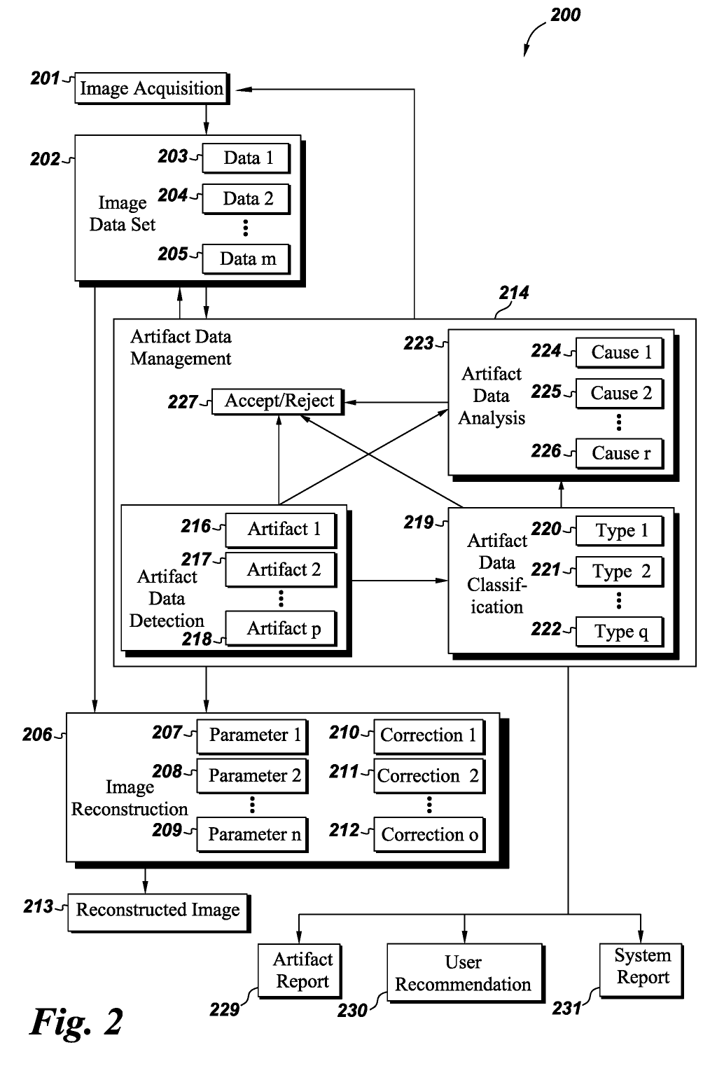

As illustrated in FIG. 2, an embodiment of an image data generation method 200 provides for artifact correction in a reconstructed image. In one aspect, the artifact correction is implemented with an MRI or CT generated image. The image acquisition 201 generates an image data set 202, which comprises a plurality of image data subsets 203, 204, 205. An image reconstruction 206 converts the image data set 202 into the reconstructed image 213, which is suitable for human interpretation. The image reconstruction process 206 is controlled by a plurality of reconstruction parameter values 207, 208, 209 and comprises a plurality of artifact correction steps 210, 211, 212. The artifact data management step 214 analyses the data subsets 203, 204, 205 before use in the image reconstruction step 206, the analysis detecting the presence of any data section(s) that can give rise to artifacts in the reconstructed image 206. The artifact data management step 214 comprises an artifact data detection step 215, an artifact data classification step 219, an artifact data analysis step 223, and a data acceptance/rejection step 227. The artifact data detection step 215 detects the artifact data 216, 217, 218 which are data patches present in the image data set 202. The artifact data classification step 219 determines the type of the artifact data 216, 217, 218, resulting in the artifact data types 220, 221, 222. The artifact data analysis step 223 determines the causes 224, 225, 226 of the artifact data 216, 217, 218, taking the classification type 220, 221, 222 into account, and identifies the parameters from the reconstruction parameters 207, 208, 209 that influence artifact formation from the artifact data 216, 217, 218. The artifact data analysis step 223 also determines the artifact correction steps from 210, 211, 212 that influence formation of artifacts from the artifact data 216, 217, 218. The acceptance/rejection step 227 predicts and evaluates the artifact content of the reconstructed image 213 resulting from the artifact data 216, 217, 218; the acceptance/rejection step determining whether or not the artifact data is minimal, or sufficiently low, as pre-determined by a user, in order to finalize the reconstructed image 213. If the artifact content of the reconstructed image 213 is not determined to be low, the data management step 214 performs at least one the following steps:
(a) ordering the image acquisition step 201 to reacquire at least one of the data subsets 203, 204, 205 that present the artifact data 216 or 217 or 218 (e.g., ordering reacquisition of data 204, but not of data 203 and data 205);
(b) modification of the artifact data of the image data set 202 to mitigate or reduce the artifact data 216, 217, 218 (e.g. modifying data 204, but not data 203 and data 205);
(c) modifying artifact-influencing reconstruction parameter values of the image reconstruction step 202 to mitigate or reduce the artifacts that otherwise result from the artifact data 216, 217, 218 (e.g. modifying parameter 208, but not parameter 207 and parameter 209);
(d) activation of artifact correction steps 210 and/or 211 and/or 212 in the reconstruction step 206 that mitigate or reduce the artifacts that otherwise result from the artifact data 216, 217, 218.

If the artifact content of the reconstructed image 213 is sufficiently low, the artifact data management step 214 releases the image data subsets 203, 204, 205 to the image reconstruction step 206 which in turn generates the reconstructed image 213. The artifact data management 214 may further take one or more of the following steps to:
(a) generate an artifact report 229 regarding any remaining and/or resolved artifacts;
(b) issue recommendations 230 to a user with respect to the remaining and/or resolved artifacts;
(c) generate the system report 231 as to the operational condition(s) of the imaging device(s).

In one aspect, the steps 201, 202, 206, 213 (See FIG. 2) correspond to the steps 101, 102, 106, 113 (See FIG. 1), respectively, and the methods presented in FIG. 1 and FIG. 2 can be implemented individually or may be combined to produce the desired effect. It is further understood that the steps of artifact data management 214, including generation of an artifact report 229, user recommendations 230, and a system report 231 from FIG. 2 are similar, but not identical, to the steps of the artifact management module 114, including generation of the artifact report 129, user recommendations 130, and a system report 131 from FIG. 1.

This disclosure therefore claims the method in which data analysis algorithms, including machine learning and/or deep learning algorithms, automatically analyze all or part of the images reconstructed by standard algorithms from one or a plurality of imaging devices for the presence of one or a plurality of artifacts of one or a plurality of different types (i.e. not knowing whether artifacts are present and not knowing the type of artifact upfront). In one aspect, standard algorithms refer to any image reconstruction algorithm that is not specifically designed to reduce and/or mitigate artifacts in the reconstructed image. In the case of artifact(s), the algorithms further: (a) classify the artifact(s) according to their cause, (b) select the artifact correction algorithm(s) (if available) to address them, and (c) select the part(s) of the data and/or parameter value(s) that are to be corrected.

Then, a second image reconstruction is performed with the selected artifact corrections yielding a second reconstructed image with less artifact content. Depending on the type of artifact(s) the procedure can be repeated a plurality of times until the artifact content of the reconstructed image is reduced to a satisfactory low level or until the artifact level cannot be reduced further by processing of the available data.

Apart from the reduction in artifact content of the finally reconstructed image, the claimed method offers the advantages of providing an observer-independent, quantitative evaluation of each reconstructed image for artifact content; providing a fast evaluation of each reconstructed image for artifact content; limiting the need for human intervention to eliminate artifacts from the reconstructed images; simplifying the workflow for invoking artifact correction techniques during image reconstruction; reducing the number of patients or objects for which image acquisition is repeated; increasing the information content of most reconstructed images, since artifact avoidance strategies can be limited to those sections of the data that effectively would lead to artifacts otherwise; providing valuable information about the operational condition and wear of the system; providing information, for exemplary purposes, and not limitation, to the operator of the imaging device or others users of the system, about artifacts in the preliminary, intermediate and/or final reconstructed image; and automatically initiating or providing recommendations for corrective actions.

To a person skilled in the art, the analysis of the acquisition data itself enables the prediction of the appearance of specific artifact(s) in the reconstructed image, e.g. ringing artifacts, in case no corrections are applied during image reconstruction. Thus, in aspects of the invention disclosed, this step can already be performed or started during data acquisition. In embodiments described herein, (i) artifact correction(s) can already be applied to the preliminary image reconstruction, (ii) parts of the data acquisition can be repeated to obtain new data that is not affected by the cause of the artifact and replace data affected by the cause of the artifact, and/or (iii) the data acquisition can be terminated early in case the cause of the artifact does not allow the acquisition of data of sufficient quality, or when continuation of the data acquisition is unsafe.

The embodiments of the invention disclosed herein automatically identify the presence and type (out of a plurality of types) of artifact(s) in medical and/or industrial images and data. The method automatically identifies and initiates, and/or recommends, the appropriate action(s) to reduce, or avoid the artifact(s).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components or steps of processes described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

1. A system comprising a non-transitory computer-readable memory device that enables an imaging system to reconstruct images from one or more imaging devices, the system comprising:
an image acquisition module that acquires a plurality of data from the one or more imaging devices;
an image reconstruction module comprising one or more parameter values; and
an artifact management module that identifies one or more data subsets comprising a plurality of artifacts, wherein the artifact management module accepts or rejects one or more of the plurality of artifacts during at least one of a classification step and an analysis step, alone or in combination; and activates one or more corrections prior to reconstructing an image in the image reconstruction module.

2. The system of claim 1, wherein the artifact management module manages artifacts by way of acceptance or rejection of one or more of the plurality of artifacts in a final image, display, or report.

3. A method that enables an imaging system to reconstruct images from one or more imaging devices, the method comprising the steps of:
providing an image acquisition module to acquire an image data set, wherein the image data set comprises a plurality of image data subsets;
providing an image reconstruction module that comprises one or more parameter values;
identifying, by way of an artifact management module, one or more of the plurality of image data subsets comprising a plurality of artifacts;
accepting or rejecting, by way of the artifact management module, one or more of the plurality of artifacts during at least one of a classification step or an analysis step, alone or in combination;
activating, by way of the artifact management module, one or more corrections prior to reconstructing an image in the image reconstruction module; and
executing the one or more corrections to adjust one or more reconstruction parameters to create a reconstructed image, wherein the plurality of artifacts in the reconstructed image are reduced.
wherein the step of identifying comprises the steps of (a) detecting one or more of the plurality of artifacts, (b) classifying one or more of the plurality of artifacts, and (c) analyzing one or more of the plurality of artifacts.

4. The method of claim 3, wherein a final image is reconstructed from the one or more imaging devices and the plurality of artifacts have a plurality of types.

5. The method of claim 3, wherein the step of classifying includes characterizing the one or more artifacts according to type.

6. The method of claim 3, wherein the step of analyzing determines the cause of one or more artifacts, including a portion of the image data subsets that is affected and values of the reconstruction parameters that cause or are affected by the one or more artifacts.

7. The method of claim 6, further comprising a step of modifying one or more of the plurality of image data subsets or one or more of the parameter values of the image reconstruction module to reduce the one or more artifacts.

8. The method of claim 7, further comprising a step of correcting the one or more artifacts when the one or more artifact correction steps are initiated to create a second reconstructed image, the step of correcting following the step of modifying.

9. The method of claim 7, wherein the steps of the method are reiterated to generate a refined image and one or more reports.

10. The method of claim 7, wherein the step of correcting is reiterated a plurality of times to refine artifact correction during each repetition.

11. The method of claim 7, further comprising a step of accepting or rejecting the reconstructed images as based on a presence or absence of the artifacts.

12. The method of claim 7, further comprising a step of providing information, by way of a processor, about the presence, type, severity, and cause of the artifacts identified in a preliminary reconstructed image, or any subsequent reconstructed image following a step of correcting.

13. The method of claim 7, further comprising a step of providing operational information as to a condition or wear of the one or more imaging systems.

14. The method of claim 7, further comprising steps of requesting and receiving information from the one or more imaging devices.

15. The method of claim 14, wherein the steps of requesting and receiving information includes information from a patient record, a physician, or an operator to differentiate causes of the one or more artifacts.

16. The method of claim 7, wherein the method is automated and controlled by way of a computer processor.

17. The method of claim 7, wherein the method is automated, and controlled by an operator as based on recommendations generated by way of a computer processor.

18. A method that enables an imaging system to reconstruct images from one or more imaging devices which comprises a plurality of artifacts of one or more types, the method comprising the steps of:
providing an image acquisition module to acquire an image data set, wherein the image data set comprises a plurality of image data subsets;
providing an image reconstruction module that manages a plurality of artifacts such that a plurality of reconstruction parameter values are selected, and one or more artifact correction steps initiated to create a reconstructed image;
identifying, by way of an artifact management module, one or more data sections that generate artifacts in a reconstructed image; the step of identifying the one or more data sections comprising the steps of (a) detecting one or more artifact data sections, (b) classifying the one or more artifact data sections according to the type, (c) analyzing the one or more artifact data sections to determine a cause of the artifact data, including affected data of the image data subsets and affected reconstruction parameters, and (d) accepting or rejecting the one or more artifact data sections;
modifying one or more of the plurality of image data subsets or the reconstruction parameter values to reduce the one or more artifact data sections;
automatically activating the one or more artifact correction steps, as based on a recommendation from the processor during the step of modifying; and
correcting the artifact data sections by processing the plurality of data subsets as designated by the step of modifying such that the plurality of reconstruction parameter values are reassessed and one or more of the artifact correction steps implemented to create a reconstructed image.

19. The method of claim 18, wherein the step of automatically activating the one or more correction steps, the recommendation issues a request to at least one imaging device to repeat the acquisition of the one or more the artifact data sections to replace respective sections in the reconstructed image.

20. The method of claim 19, wherein the request is executed based on approval by an operator.

21. The method of claim 19, wherein the steps of the method are reiterated until the image data set is acquired to a predefined level of quality.

22. The method of claim 21, wherein the one or more imaging devices comprise a magnetic resonance imaging (MRI) system, a computed tomography (CT) system, a single-photon emission computed tomography (SPECT) system, and a positron emission tomography (PET) system.

23. The method of claim 19, wherein the artifact management module terminates acquisition of the image data set or provides a recommendation to the operator when the predefined level of quality is reached or when the step of analyzing reveals a safety issue.

24. The method of claim 19, further comprising a step of providing information, by way of a processor, about the presence, type, severity, and cause of artifacts identified in the image data subsets.

25. The method of claim 19, further comprising a step of providing operational information as to a condition or wear of the one or more imaging systems.
